(19) United States
(12) Patent Application Publication
(10) Pub. No.: US 2018/0357193 A1
(43) Pub. Date: Dec. 13, 2018

(54) COMPUTING DEVICE AND OPERATION METHOD

(71) Applicants: INVENTEC (PUDONG) TECHNOLOGY CORPORATION, Shanghai City (CN); INVENTEC CORPORATION, Taipei City (TW)

(72) Inventors: Peng ZHAN, Shanghai City (CN); Wei-Guo GUO, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/641,161

(22) Filed: Jul. 3, 2017

(30) Foreign Application Priority Data
Jun. 12, 2017 (CN) 201710440458.2

(51) Int. Cl. G06F 13/364; G06F 13/42; G06F 13/40

(52) U.S. Cl. CPC G06F 13/364; G06F 2213/0016; G06F 13/404; G06F 13/4282

(57) ABSTRACT

A computing device adapted to a server having a baseboard management controller. The computing device includes a first inter-integrated circuit (I²C) bus, a storage unit, a second I²C bus, and a first register. The first I²C is configured to connect to the baseboard management controller. The storage unit is connected to the first I²C and configured to store firmware data of the computing device. The second I²C is configured to connect to the baseboard management controller. The first register is connected to the second I²C and a first set of general-purpose input/output (GPIO) pins. The first register is configured to obtain and store a first status message of a first system device through the GPIO pins. The baseboard management controller programs the firmware data into the storage unit through the first I²C, and read the first status message through the second I²C.

### CROSS-REFERENCE TO RELATED APPLICATIONS

This non-provisional application claims priority under 35 U.S.C. § 119(a) on Patent Application No(s). 201710440458.2 filed in China. On Jun. 12, 2017, the entire contents of which are hereby incorporated by reference.

### TECHNICAL FIELD

The disclosure relates to a computing device and an operation method, more particularly to a computing device and an operation method using inter-integrated circuit buses.

### BACKGROUND

In general, firmware data has to be programmed into a computing device (e.g. complex programmable logic device (CPLD) of a server so that the computing device would be able to operate normally based on the firmware data programmed. The firmware data is usually programmed into the computing device via programmers provided by manufacturers, simulations of JTAG interfaces performed by baseboard management controllers of a server, or peer-to-peer structures consisting of switches. However, programming the firmware data into the computing device in such ways will waste resources of baseboard management controllers, such as general-purpose input/output pins.

Furthermore, the version of the computing device and operation status information related to other system devices in a server can not be obtained directly through the computing device, so it is inconvenient to confirm whether the version of the computing device is correct or not, and to perform debugging procedures for the system devices. Therefore, how firmware data is programmed into a computing device using few resources and how version information of the computing device and the status information of system devices can be obtained through the computing device have become an important issue in this field.

### SUMMARY

According to one embodiment of the present disclosure, a computing device adapted to a server with a baseboard management controller is disclosed. The computing device comprises a first inter-integrated circuit bus, a storage unit, a second inter-integrated circuit bus and a first register. The first inter-integrated circuit bus is configured to connect to the baseboard management controller. The storage unit is connected to the first inter-integrated circuit bus and configured to store firmware data of the computing device. The second inter-integrated circuit bus is configured to connect to the baseboard management controller. The first register is connected to the second inter-integrated circuit bus and a first set of general-purpose input/output pins. The first register is configured to obtain and store a first status message related to a first system device through the first set of general-purpose input/output pins. The computing device is configured to receive a programming command from the baseboard management controller for the baseboard management controller to program the firmware data into the storage unit through the first inter-integrated circuit bus, and the computing device is configured to receive a reading command from the baseboard management controller for the baseboard management controller to read the first status message stored in the first register through the second inter-integrated circuit bus. In one embodiment, the computing device has version information stored in the first register for the baseboard management controller to read the version information stored in the first register through the second inter-integrated circuit bus.

According to another embodiment of the present disclosure, a computing device adapted to a server with a baseboard management controller is disclosed. The computing device comprises a first inter-integrated circuit bus and a storage unit. The first inter-integrated circuit bus is configured to connect to the baseboard management controller. The storage unit is connected to the first inter-integrated circuit bus and configured to store firmware data of the computing device. The baseboard management controller programs the firmware data into the storage unit according to a programming command. A second inter-integrated circuit bus is constructed and a register is defined within the computing device when the computing device starts to operate according to the firmware data stored in the storage unit, and the second inter-integrated circuit bus is respectively connected to the baseboard management controller and the register. The register is configured to obtain and store a status message related to a system device through a set of general-purpose input/output pins, and the computing device is configured to receive a reading command from the baseboard management controller for the baseboard management controller to read the status message stored in the register through the second inter-integrated circuit bus.

According to one embodiment of the present disclosure, an operation method adapted to a computing device and a server with a baseboard management controller is disclosed. The computing device comprises a first inter-integrated circuit bus connected to the baseboard management controller. The operation method comprises the following steps: programming firmware data of the computing device into a storage unit of the computing device through the first inter-integrated circuit bus according to a programming command; constructing a second inter-integrated circuit bus as well as defining a register within the computing device when the computing device starts to operate according to the firmware data programmed into the storage unit of the computing device. The register is configured to store a status message of a system device. The computing device is configured to receive a reading command from the baseboard management controller so that the baseboard management controller reads the status message stored in the register through the second inter-integrated circuit bus, and the computing device is configured to receive a control command from the baseboard management controller so that the baseboard management controller controls an electric potential of the system device through the second inter-integrated circuit bus.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a server and a client thereof according to one embodiment of the present disclosure;

FIG. 2 is a block diagram of a server and a client thereof according to another embodiment of the present disclosure;

FIG. 3 is a block diagram of a server and a client thereof according to further another embodiment of the present disclosure; and

FIG. 4 is a flow chart of operation method according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

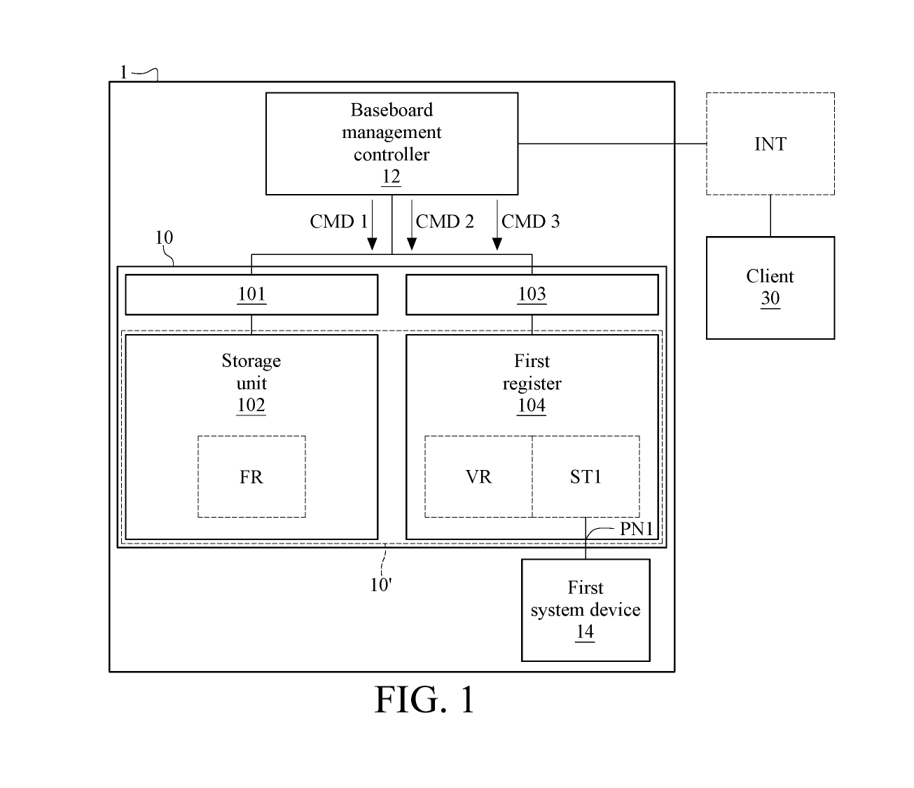

Please refer to FIG. 1, which is a block diagram of a server and a client thereof according to one embodiment of the present disclosure. As shown in FIG. 1, a server 1 includes a computing device 10, a baseboard management controller 12 and a first system device 14. The computing device 10 includes a first inter-integrated circuit bus 101, a storage unit 102, a second inter-integrated circuit bus 103 and a first register 104. The first inter-integrated circuit bus 101 is configured to connect to the baseboard management controller 12. The storage unit 102 is connected to the first inter-integrated circuit bus 101. The storage unit 102 is configured to store firmware data FR of the computing device 10. In practice, the computing device 10 could be a complex programmable logic device (CPLD), which needs specific firmware data installed for operation. The firmware data FR is usually programmed into the CPLD and stored in a storage unit of the CPLD. The storage unit 102 could be a memory having function of storing data. In one example, the storage unit 102 and the first register 104 are both located within a storage medium 10′ of the computing device 10 as shown in FIG. 1. In another example, the storage unit 102 and the first register 104 are respectively located within their corresponding storage medium of the computing device 10.

The second inter-integrated circuit bus 103 is configured to connect to the baseboard management controller 12. The first register 104 is connected to the second inter-integrated circuit bus 103 and a first set of general purpose input/output pins PN1. The first register 104 is configured to obtain and store a first status message ST1 related to the first system device 14 through the first set of general purpose input/output pins PN1. In one example, the first system device 14 could be a system power disposed in the server 1. However, the present disclosure is not limited to the above example.

In the embodiment of FIG. 1, the computing device 10 is configured to receive a programming command CMD1 from the baseboard management controller 12 for the baseboard management controller 12 to program the firmware data FR into the storage unit 102 through the inter-integrated circuit bus 101. Specifically, when a user would like to let the firmware data FR to be programmed into the computing device 10, the baseboard management controller 12 gives the programming command CMD1 so that the computing device 10 receives the programming command CMD1. Thereby the firmware data FR required by the computing device 10 can be sent to the computing device 10 and stored in the storage unit 102 through the inter-integrated circuit bus 101. In practice, the baseboard management controller 12 could be coupled to a plurality of computing devices. Since data is transmitted under the communication structures of inter-integrated circuit buses based on functions of addresses, only few pins of the baseboard management controller would be used for processing firmware programming for a plurality of computing devices. Therefore, the waste of the resources of the baseboard management controller is reduced. Furthermore, because the size of the programming files used by the computing device of the present disclosure is significantly smaller than the size of the programming files used by a traditional device (e.g. device using JTAG simulated structure), the programming speed of the computing device of the present disclosure is significantly higher than the programming speed of the traditional device.

On the other hand, the computing device 10 is further configured to receive a reading command CMD2 from the baseboard management controller 12 for the baseboard management controller 12 to read a first status message ST1 stored in the first register 104 through the second inter-integrated circuit bus 103. Specifically, when the user would like to know about the operation status (e.g. the first status message ST1) related to the first system device 14 in the server 1, the user controls the baseboard management controller 12 to give the reading command CMD2 so that the computing device 10 receives the reading command CMD2. Thereby the first register 104 obtains and stores the operation status information (e.g. the first status message ST1) related to the system device 14 through the first set of general purpose input/output pins PN1 according to the reading command CMD2. Then the baseboard management controller 12 is capable of reading the first status message ST1 of the first system device 14 through the second inter-integrated circuit bus 103. In one embodiment, the first status message ST1 could be power information or temperature status information of a system power in a server. In a practical operation, the first status message ST1 contains electric potential information. The baseboard management controller 12 may obtain the electric potential information of the first status message ST1 by accessing the first register 10 through the second inter-integrated circuit bus 103 for determining whether the first system device 14 operates normally or not. For example, if the first system device 14 operates abnormally, the electric potential information of the first status message ST1 indicates that the electric potential is low. In other words, when the electric potential information of the first status message ST1 read by the baseboard management controller 12 from the first register 10 indicates that the electric potential is low, it could be determined that the first system device 14 operate abnormally. Thereby, the convenience of debugging for the system device is raised.

In one embodiment, the computing device 10 is further configured to receive a control command CMD3 from the baseboard management controller 12 for the baseboard management controller 12 to control an electric potential of the first system device 14 through the second inter-integrated circuit bus 103. In practice, the first system device 14 has a corresponding electric potential, and the baseboard management controller 12 may give the control command CMD3 through the second inter-integrated circuit bus 103 for the first system device 14 to switch the corresponding electric potential according to the control command CMD3. In one embodiment, the computing device 10 has version information VR stored in the first register 104. The baseboard management controller 12 may read the version information VR stored in the first register 104 through the second inter-integrated circuit bus 103. In other words, by the computing device of the present disclosure, the version of the computing device 10 can be confirmed efficiently so that it is easy to process certification and upgrade of the version of the computing device.

In one embodiment, the baseboard management controller 12 of the server 1 is connected to a client 30 via an Ethernet network INT, as shown in FIG. 1. The programming command CMD1 and the firmware data FR come from the client 30. More specifically, the user may control the client 30 to give the programming command CMD1 and send the firmware data FR to the baseboard management controller 12 via the Ethernet network INT. Therefore, remote firmware programming of the computing device 10 can be achieved.

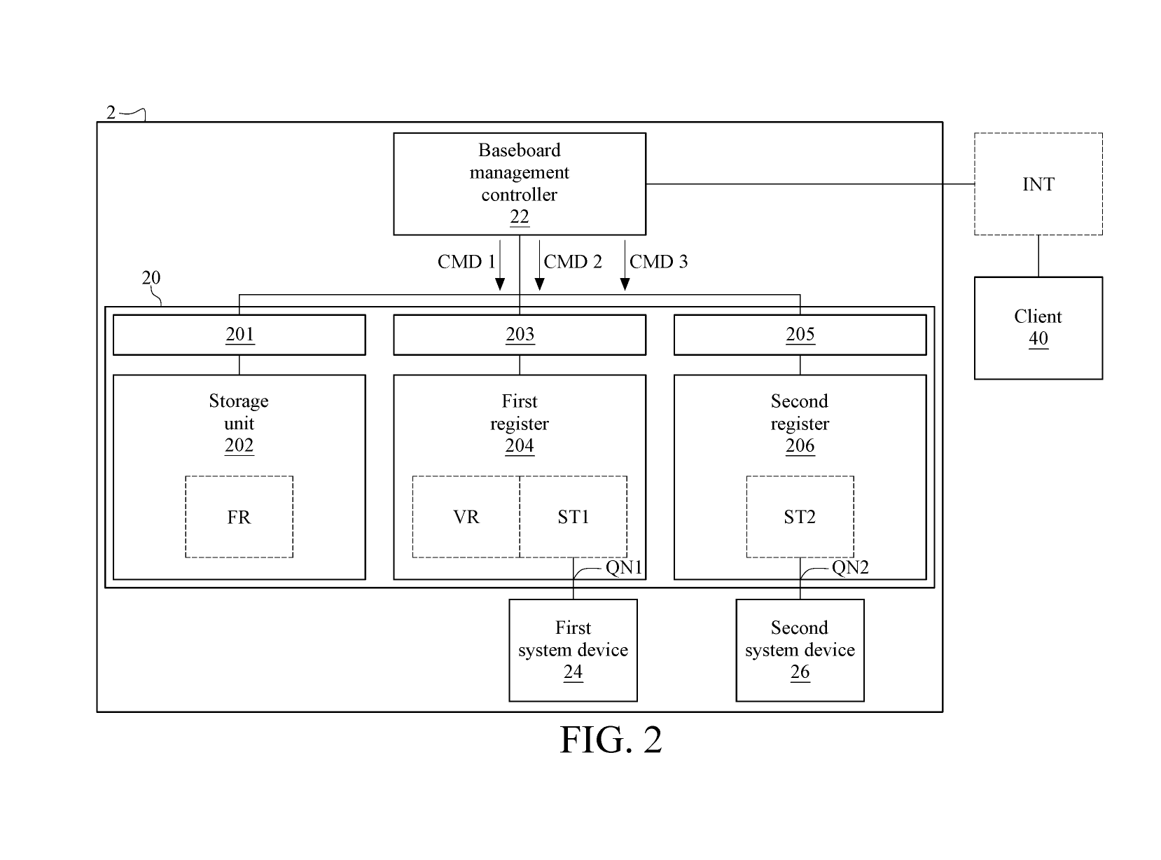

Please refer to FIG. 2, which is a block diagram of a server and a client thereof according to another embodiment of the present disclosure. Similar to the embodiment of FIG. 1, a server 2 is connected to a client 40 via an Ethernet network INT in FIG. 2, and the server 2 includes a computing device 20, a baseboard management controller 22 and a first system device 24. The computing device 20 includes a first inter-integrated circuit bus 201, a storage unit 202, a second inter-integrated circuit bus 203 and a first register 204. Basically, the operation of the computing device 20 in FIG. 2 is similar to the operation of the computing device 10 in FIG. 1. However, different from that of FIG. 1, the computing device 20 further includes a third inter-integrated circuit bus 205 and a second register 206 in FIG. 2. The third inter-integrated circuit bus 205 is connected to the baseboard management controller 22. The second register 206 is connected to the third inter-integrated circuit bus 205 and a second set of general purpose input/output pins QN2 different from the first set of general purpose input/output pins QN1. The second register 206 is configured to obtain and store a second status message ST2 related to the second system device 26 through the second set of general purpose input/output pins QN2.

The computing device 20 is configured to receive another reading command CMD2 from the baseboard management controller 22 for the baseboard management controller 22 to read the second status message ST2 stored in the second register 206 through the third inter-integrated circuit bus 205. The computing device 20 is also configured to receive another control command CMD3 from the baseboard management controller 22 for the baseboard management controller 22 to control the electric potential of the second system device 26 through the third inter-integrated circuit bus 205. In this embodiment, the computing device 20 includes two registers, but the present disclosure is not limited to the embodiment. In fact, in another embodiment, the computing device of the present disclosure may include three or more than three registers such that a large number of system devices in the server could be controlled and their corresponding status messages could be read.

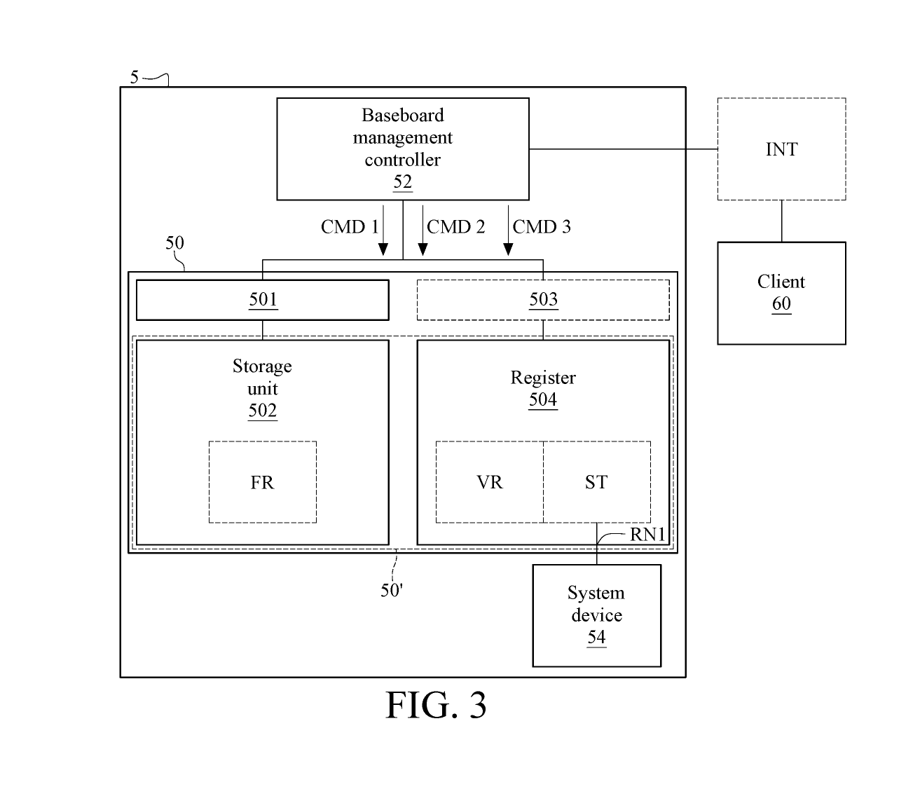

Please refer to FIG. 3, which is a block diagram of a server and a client thereof according to another embodiment of the present disclosure. As shown in FIG. 3, the server 5 is connected to the client 60 via an Ethernet network INT, and the server 5 includes a computing device 50 and a baseboard management controller 52. The computing device 50 includes a first inter-integrated circuit bus 501 and a storage unit 502. The first inter-integrated circuit bus 501 is connected to the baseboard management controller 52. The storage unit 502 is connected to the first inter-integrated circuit bus 501. The storage unit 502 is configured to store the firmware data FR of the computing device 50. The baseboard management controller 52 is configured to program firmware data FR into the storage unit 502 according to the programming command CMD1. When the computing device 50 starts to operate according to the firmware data FR stored in the storage unit 502, a second inter-integrated circuit bus 503 is constructed by coding in the computing device 50 and a register 504 is defined.

More specifically, the difference between the embodiment of FIG. 3 and those of FIG. 1 and FIG. 2 lies in that, initially, the computing device 50 includes the first inter-integrated circuit bus 501 and the storage unit 502 only. The computing device 50 starts to operate according to firmware data FR after the firmware data FR of the computing device 50 is programmed into the computing device 50 and stored in the storage unit 502. Then, the second inter-integrated circuit bus 503 could be constructed by coding for transmitting data based on the communication protocol of an inter-integrated circuit bus (I²C). Furthermore, a register 504 is defined within the computing device 50. The second inter-integrated circuit bus 503 is connected to the baseboard management controller 52 and the register 504. The register 504 obtains and stores a status message ST related to a system device 54 through a set of general purpose input/output pins RN1. The computing device 50 is configured to receive a reading command CMD2 from the baseboard management controller 52 for the baseboard management controller 52 to read the status message ST stored in the register 504 through the second inter-integrated circuit bus 503. In one example, the storage unit 502 and the first register 504 are both located in a storage medium 50′ of the computing device 50 as shown in FIG. 3. In another example, the storage unit 502 and the first register 504 may be located in their corresponding storage medium of the computing device 50.

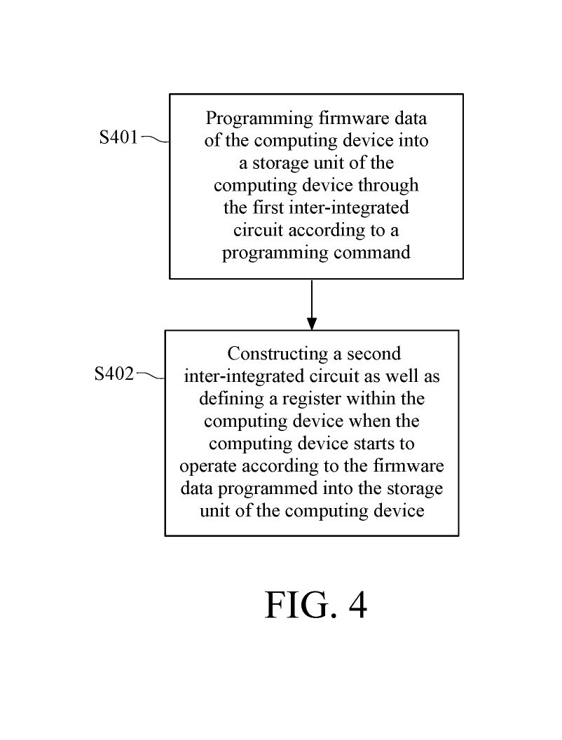

Please refer to FIG. 3 and FIG. 4. FIG. 4 is a flow chart of operation method according to one embodiment of the present disclosure. The operation method is adapted to the computing device 50 and the baseboard management controller 52 of the server 5 in FIG. 3. As shown in FIG. 4, in step S401, the firmware data FR of the computing device 50 is programmed into the storage unit 501 of the computing device 50 through the first inter-integrated circuit bus 501 according to the programming command CMD1 of the baseboard management controller 52. Then in step S402, the second inter-integrated circuit bus 503 is constructed and the register 504 is defined within the computing device 50 when the computing device 50 starts to operate according to the firmware data FR programmed into the storage unit 501 of the computing device 50. The register 504 is configured to store the status message ST related to the system device 54. The computing device 50 is configured to receive the reading command CMD2 from the baseboard management controller 52 for the baseboard management controller 52 to read the status message ST stored in the register 504 through the second inter-integrated circuit bus 503. On the other hand, the computing device 50 is configured to receive the control command CMD3 for the baseboard management controller 52 to control the electric potential of the system device 54 through the second inter-integrated circuit bus 503.

Based on the above descriptions, in the computing device and operation method of the present disclosure, the inter-integrated circuit buss are applied to the computing device, and the programming of the firmware data for the computing device in the server is achieved based transmission structure of the inter-integrated circuit buses with functions of addresses. Therefore, the waste of resources of the baseboard management controller is reduced and the programming speed is improved during the procedure of programming firmware data into the computing device. Furthermore, by inter-integrated circuit buses, the version information of the computing device as well as the status information related to the internal system devices in the server could be read so that confirmation of the version of the computing device and debugging procedures for the system devices can be achieved.

What is claimed is:

1. A computing device adapted to a server with a baseboard management controller, comprising:
a first inter-integrated circuit bus configured to connect to the baseboard management controller;
a storage unit connected to the first inter-integrated circuit bus and configured to store firmware data of the computing device;
a second inter-integrated circuit bus configured to connect to the baseboard management controller; and
a first register connected to the second inter-integrated circuit bus and a first set of general-purpose input/output pins, with the first register configured to obtain and store a first status message related to a first system device through the first set of general-purpose input/output pins;
wherein the computing device is configured to receive a programming command from the baseboard management controller for the baseboard management controller to program the firmware data into the storage unit through the first inter-integrated circuit bus, and the computing device is configured to receive a reading command from the baseboard management controller for the baseboard management controller to read the first status message stored in the first register through the second inter-integrated circuit bus.

2. The computing device according to claim 1, wherein the computing device has version information stored in the first register for the baseboard management controller to read the version information stored in the first register through the second inter-integrated circuit bus.

3. The computing device according to claim 1, wherein the programming command and the firmware data are sent from a client connected to the baseboard management controller via an Ethernet network, and the programming command and the firmware data are sent to the baseboard management controller via the Ethernet network.

4. The computing device according to claim 1, wherein the computing device is configured to receive a control command from the baseboard management controller for the baseboard management controller to control an electric potential of the first system device through the second inter-integrated circuit bus.

5. The computing device according to claim 1, wherein the storage unit and the first register are located in a storage medium.

6. The computing device according to claim 1, wherein the first status message includes at least one of power information and temperature status information of the first system device.

7. The computing device according to claim 1, further comprising:
a third inter-integrated circuit bus configured to connect to the baseboard management controller; and
a second register connected to the third inter-integrated circuit bus and a second set of general-purpose input/output pins, with the second register configured to obtain and store a second status message related to a second system device through the second set of general-purpose input/output pins;
wherein the computing device is configured to receive another reading command from the baseboard management controller for the baseboard management controller to read the second status message stored in the second register through the third inter-integrated circuit bus, and the computing device is configured to receive another control command from the baseboard management controller for the baseboard management controller to control an electric potential of the second system device through the third inter-integrated circuit bus.

8. A computing device adapted to a server with a baseboard management controller, comprising:
a first inter-integrated circuit bus configured to connect to the baseboard management controller; and
a storage unit connected to the first inter-integrated circuit bus and configured to store firmware data of the computing device, with the baseboard management controller programming the firmware data into the storage unit according to a programming command, wherein a second inter-integrated circuit bus is constructed and a register is defined within the computing device when the computing device starts to operation according to the firmware data stored in the storage unit, and the second inter-integrated circuit bus is respectively connected to the baseboard management controller and the register;
wherein the register is configured to obtain and store a status message related to a system device through a set of general-purpose input/output pins, and the computing device is configured to receive a reading command from the baseboard management controller for the baseboard management controller to read the status message stored in the register through the second inter-integrated circuit bus.

9. The computing device according to claim 8, wherein the storage unit and the register are located in a storage medium.

10. An operation method adapted to a computing device and a server with a baseboard management controller, with the computing device comprising a first inter-integrated circuit bus connected to the baseboard management controller, the operation method comprising:
programming firmware data of the computing device into a storage unit of the computing device through the first inter-integrated circuit bus according to a programming command; and
constructing a second inter-integrated circuit bus as well as defining a register within the computing device when the computing device starts to operate according to the firmware data programmed into the storage unit of the computing device, wherein the register is configured to store a status message of a system device;
wherein the computing device is configured to receive a reading command from the baseboard management controller so that the baseboard management controller reads the status message stored in the register through the second inter-integrated circuit bus, and the computing device is configured to receive a control command from the baseboard management controller so that the baseboard management controller controls an electric potential of the system device through the second inter-integrated circuit bus.
